(19) United States
(12) Patent Application Publication
(10) Pub. No.: US 2012/0051204 A1
(43) Pub. Date: Mar. 1, 2012

(54) OPTICAL PICKUP

(75) Inventors: Kunikazu OHNISHI, Yokosuka (JP); Kazuyoshi YAMAZAKI, Yamato (JP); Mitsuru NAGASAWA, Zama (JP)

(73) Assignee: Hitachi Media Electronics Co., Ltd.

(21) Appl. No.: 13/070,960

(22) Filed: Mar. 24, 2011

(30) Foreign Application Priority Data
Aug. 31, 2010 (JP) 2010-193268

(51) Int. Cl. G11B 7/135

(52) U.S. Cl. 369/112.03; G9B/7.112

(57) ABSTRACT

An optical pickup compatible with two wavelengths such as an optical pickup having a two-wavelength, multi-laser source unit to be compatible with both DVDs and CDs prevents, in a simply structured optical system, error signal quality deterioration caused by relative shifting between laser beams and realizes detection of focus and tracking error signals. The optical system is provided with an optical waveguide device and a photodetector. The optical waveguide device includes a holographic diffraction grating having three regions divided by two approximately parallel division lines which extend respectively passing the optical axes of a laser beam for DVD and a laser beam for CD. The photodetector has plural light receiving surfaces each divided into three regions. This allows reliable focus and tracking error signals to be detected during both DVD reproduction and CD reproduction.

### INCORPORATION BY REFERENCE

This application relates to and claims priority from Japanese Patent Application No. 2010-193268 filed on Aug. 31, 2010, the entire disclosure of which is incorporated herein by reference.

### BACKGROUND OF THE INVENTION

(1) Field of the Invention

The present invention relates to an optical pickup including plural laser sources and being capable of reproducing information signals recorded on plural types of optical information recording media.

(2) Description of the Related Art

In recent years, optical pickups each usable as a multi-media compatible optical pickup capable of recording or reproducing information on or from plural types of optical information recording media (hereinafter referred to as “optical discs” for simplification) using mutually different wavelengths, for example, DVDs and CDs, or BDs and DVDs have come into use. Such optical pickups each have a multi-laser source unit including plural semiconductor laser chips which are installed in a same housing and emit laser beams of different wavelengths corresponding to different optical discs. Optical parts such as lenses, beam splitters, and photodetectors included in such optical pickups are commonly used to process different laser beams.

In such multi-media compatible optical pickups each having a multi-laser source unit, a so-called three-beam method for detecting a tracking error signal has been most generally used. A typical example of a three-beam method is disclosed in Japanese Patent Application Laid-Open No. 2003-317280. In the three-beam method, a laser beam emitted from a laser source is separated, using an optical part such as a diffraction grating, into three laser beams, and the three laser beams are converged, using an objective lens, to form three condensed light spots on a corresponding optical disc.

### SUMMARY OF THE INVENTION

When the three-beam method is used to detect a tracking error signal, however, it is necessary to strictly adjust the direction along which the three light spots are formed on an optical disc corresponding to a laser beam emitted from a multi-laser source unit relative to the recording track direction of the optical disc. When a multi-media compatible optical pickup like the one described above including a multi-laser source unit and common optical parts, e.g. a lens and a beam splitter, for multiple media is used, however, it is extremely difficult to make such adjustment for each laser beam emitted from the multi-laser source unit. When convenience in assembling and adjusting an optical pickup is taken into consideration, therefore, it is preferable, for a multi-media compatible optical pickup including a multi-laser source unit, to use a so-called one-beam method in which one light spot is formed on an optical disc and a focus error signal and a tracking error signal are detected from the laser beam reflected from the light spot.

In a multi-media compatible optical pickup having a multi-laser source unit, plural semiconductor laser chips arranged in a same housing are spaced apart by a predetermined distance, so that the laser beams emitted from the plural semiconductor laser chips are inevitably shifted from one another by a certain distance. When a one-beam method is used to detect a focus error signal and a tracking error signal, relative shifting between laser beams is a major cause of error signal quality deterioration.

The present invention has been made in view of the above circumstances, and it is an object of the invention to provide an optical pickup which, including a multi-laser source unit, is compatible with multiple recording media and realizes, by preventing quality deterioration of the focus and tracking error signals caused by relative shifting between laser beams, satisfactory detection of the focus and tracking error signals by a one-beam method in a simply structured optical system.

To achieve the above object, the present invention provides an optical pickup for reading information recorded on an optical information recording medium by irradiating the medium with a laser beam.

The optical pickup comprises: a laser source unit which houses a plurality of laser emitting devices for emitting a plurality of laser beams mutually differing in wavelength; an objective lens which forms, by converging a laser beam emitted from the laser source unit, a converged light spot on an information recording surface of the optical information recoding medium; an optical waveguide device on which a laser beam reflected from the information recording surface where the converged light spot is formed is incident and which emits a zeroth-order beam and positive and negative first-order diffracted beams generated from the reflected laser beam; and a photodetector having a plurality of light receiving surfaces on each of which the zeroth-order beam or positive or negative first-order diffracted beam generated, by the optical waveguide device, from the reflected laser beam is incident and each of which outputs a light detection signal corresponding to an optical intensity of the beam incident thereon.

In the optical pickup, the optical waveguide device has at least three divided regions divided by at least two division lines extending, on the optical waveguide device, approximately in parallel with a direction along which a recording track of the optical information recording medium extends, the divided regions each causing a zeroth-order beam out of the reflected laser beam to be incident on one, on which none of the positive and negative first-order diffracted beams is incident, of the light receiving surfaces of the photodetector.

According to the present invention, a multi-media compatible optical pickup including a multi-laser source unit enables satisfactory detection of focus and tracking error signals using a one-beam method in a simply structured optical system.

### BRIEF DESCRIPTION OF THE DRAWINGS

These and other features, objects and advantages of the present invention will become more apparent from the following description when taken in conjunction with the accompanying drawings wherein:

FIG. 1 is a side view showing parts arrangement in an optical pickup according to an embodiment of the present invention;

FIG. 2 is a plan view of an optical waveguide device used in the embodiment;

FIG. 3 is a first side view of a laser beam for DVD reproduction according to the embodiment;

FIG. 4 is a second side view of the laser beam for DVD reproduction according to the embodiment;

FIG. 5 is a third side view of the laser beam for DVD reproduction according to the embodiment;

FIG. 6 is a fourth side view of the laser beam for DVD reproduction according to the embodiment;

FIG. 7 is a first side view of a laser beam for CD reproduction according to the embodiment;

FIG. 8 is a second side view of the laser beam for CD reproduction according to the embodiment;

FIG. 9 is a third side view of the laser beam for CD reproduction according to the embodiment;

FIG. 10 is a fourth side view of the laser beam for CD reproduction according to the embodiment;

FIG. 11 is a circuit diagram for describing arithmetic processing performed during DVD reproduction according to the embodiment; and

FIG. 12 is a circuit diagram for describing arithmetic processing performed during CD reproduction according to the embodiment.

### DETAILED DESCRIPTION OF THE PREFERRED EMBODIMENT

An embodiment of the present invention will be described below with reference to drawings.

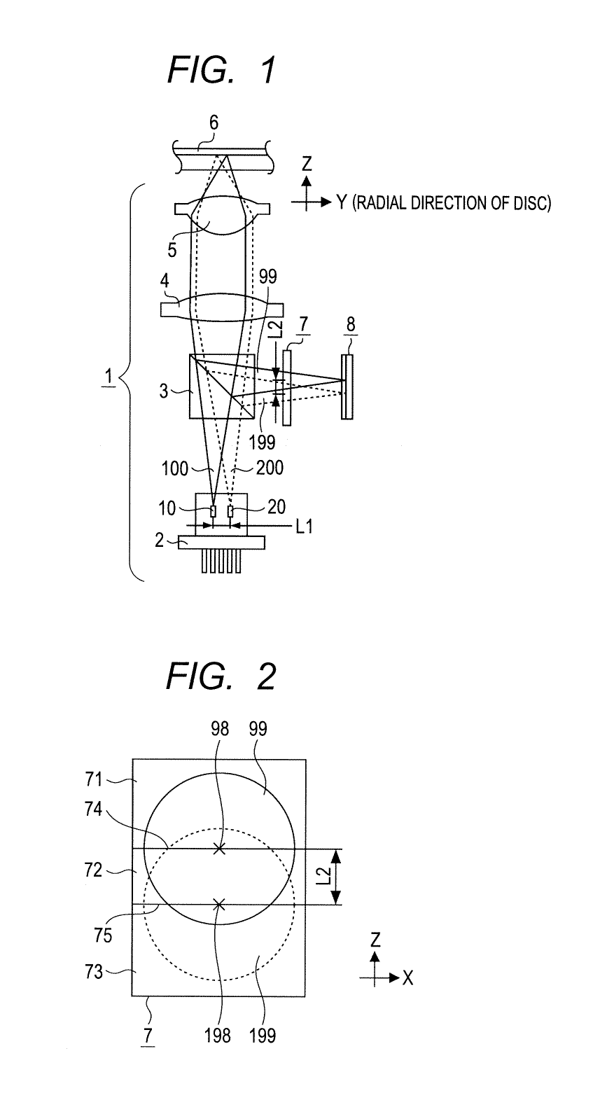

FIG. 1 shows approximate parts arrangement in an optical system of an optical pickup according to an embodiment of the present invention.

An optical pickup 1 includes a multi-laser source unit 2 housing both a semiconductor laser chip 10 which emits a laser beam with a wavelength of 650 to 660 nm used for DVD recording or reproduction and a semiconductor laser chip 20 which emits a laser beam with a wavelength of 780 to 790 nm used for CD recording or reproduction. When recording or reproducing information on or from a DVD, the semiconductor laser chip 10 lights and emits a divergent laser beam 100. When recording or reproducing information on or from a CD, the semiconductor laser chip 20 lights and emits a divergent laser beam 200. The semiconductor laser chip 10 used for DVD recording/reproduction (hereinafter referred to as the “semiconductor laser chip 10 for DVD”) and the semiconductor laser chip 20 used for CD recording/reproduction (hereinafter referred to as the “semiconductor laser chip 20 for CD”) included in the multi-laser source unit 2 are, as shown in FIG. 1, spaced apart by a distance L1.

The divergent laser beam 100 or 200 emitted from the semiconductor laser chip 10 or 20 included in the multi-laser source unit 2 reaches a coupling lens 4 via a beam splitter 3, then, after being converted into an approximately parallel laser beam by the coupling lens 4, reaches an objective lens 5 compatible with two wavelengths. The laser beam is then converged by the objective lens 5 to form a predetermined converged light spot on a predetermined recording track of an optical disc 6. The semiconductor laser chips 10 and 20 included in the multi-laser source unit 2 are arranged such that the converged light spot for DVD reproduction and that for CD reproduction are formed along a direction approximately perpendicular to a recording track on the optical disc 6, i.e. along a direction approximately in parallel with the radial direction of the optical disc 6.

The laser beam reflected from the optical disc 6 travels back the optical path followed, as described above, by the incident laser beam and reaches the beam splitter 3 via the objective lens 5 and coupling lens 4 causing a laser beam accounting for at least a portion of intensity of the reflected laser beam to be reflected from the beam splitter 3 to reach, as a laser beam 99 for DVD reproduction or as a laser beam 199 for CD reproduction, an optical waveguide device 7. The optical waveguide device 7 is a principal part of the present embodiment and has a function, for example, like that of a diffraction grating, to diffract an incident laser beam into a predetermined direction. The optical waveguide device 7 is, as being described later, divided by at least two division lines into at least three regions which diffract the corresponding incident laser beams into different directions, respectively, so as to guide the respectively diffracted laser beams to respectively different light receiving surfaces arranged on a photodetector 8.

Next, examples of the optical waveguide device 7 and photodetector 8 shown in FIG. 1 will be described.

FIG. 2 is a plan view showing an approximate structure of the optical waveguide device 7. The optical waveguide device 7 is a so-called holographic diffraction grating having a transparent flat substrate on which unequally spaced, curved grating grooves are formed.

With, as described above, the semiconductor laser chip 10 for DVD and semiconductor laser chip 20 for CD spaced apart by the distance L1 in the multi-laser source unit 2, the laser beam 99 for DVD and laser beam 199 for CD are incident on spots on the optical waveguide device 7 which are shifted from each other by a predetermined distance (shown, in FIG. 2, as a distance L2 between optical axes 98 and 198 of the laser beams 99 and 199) in a predetermined direction (shown, in FIG. 2, as a Z-axis direction).

Referring to FIG. 2, the optical waveguide device 7 is divided into three regions 71, 72, and 73 by division lines 74 and 75. The division lines 74 and 75 extend passing, with the objective lens 5 neutrally positioned, the optical axes 98 and 198 of the laser beam 99 for DVD and laser beam 199 for CD, respectively, in a direction (X-axis direction in the case shown in FIG. 2) perpendicular to the direction in which the laser beams 99 and 199 are shifted from each other. The grating grooves formed in the three divided regions of the holographic diffraction grating are optimally patterned, respectively, such that, as being described laser, the laser beam 99 for DVD and laser beam 199 for CD incident on the three divided regions are diffracted into different directions to reach different light receiving surfaces arranged on the photodetector 8.

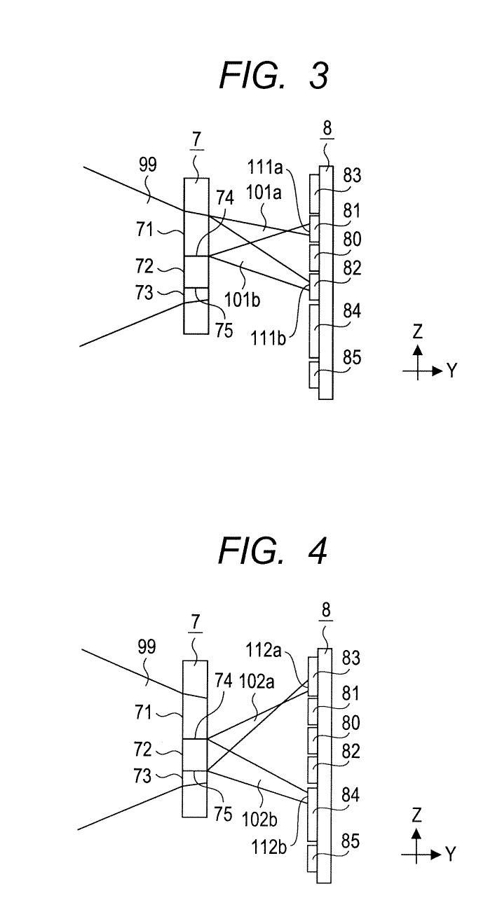

Namely, when the laser beam 99 for DVD is incident on the optical waveguide device 7 during DVD reproduction, positive first-order diffracted beams and negative first-order diffracted beams are generated. Referring to FIG. 3, the portion incident on the divided region 71 of the laser beam 99 is diffracted to generate a positive first-order diffracted beam 101a and a negative first-order diffracted beam 101b.

The positive first-order diffracted beam 101a hits a light receiving surface 81 which is the second from top out of a total of six light receiving surfaces 80 to 85 arranged in the photodetector 8.

The positive first-order diffracted beam 101a is subjected to a predetermined positive lens power, i.e. a power equivalent to that of a converging lens, generated by the holographic diffraction grating provided in the divided region 71. In a state where the light spot converged on the optical disc 6 is precisely focused, a focal point is formed in front of the photodetector 8 as shown in FIG. 3 causing a light spot 111a defocused by a predetermined amount to be formed on the light receiving surface 81 in the photodetector 8.

The negative first-order diffracted beam 101b, on the other hand, hits the light receiving surface 82 that is the fourth from top out of the six light receiving surfaces 80 to 85 as shown in FIG. 3.

Since, as described above, the positive first-order diffracted beam 101a is subjected to a predetermined positive lens power generated by the holographic diffraction grating provided in the divided region 71, the negative first-order diffracted beam 101b is inevitably subjected to a negative lens power, i.e. a power equivalent to that of a diverging lens, so that, as shown in FIG. 3, a light spot 111b defocused by a predetermined amount in a direction opposite to the direction in which the light spot 111a is defocused is formed on the light receiving surface 82.

Exactly like in the case of the portion incident on the divided region 71 of the laser beam 99, the portion hitting the divided region 72 of the laser beam 99 for DVD incident on the optical waveguide device 7 causes a positive first-order diffracted beam 102a and a negative first-order diffracted beam 102b to be generated as shown in FIG. 4. The positive first-order diffracted beam 102a is, like the positive first-order diffracted beam 101a, subjected to a positive lens power and forms a light spot 112a defocused, like the light spot 111a, by a predetermined amount on the light receiving surface 83 that is the top one of the six light receiving surfaces 80 to 85 arranged in the photodetector 8 as shown in FIG. 4.

The negative first-order diffracted beam 102b, on the other hand, is, like the negative first-order diffracted beam 101b, subjected to a negative lens power and forms a light spot 112b defocused, like the light spot 111b, by a predetermined amount in a direction opposite to the direction in which the light spot 112a is defocused on the light receiving surface 84.

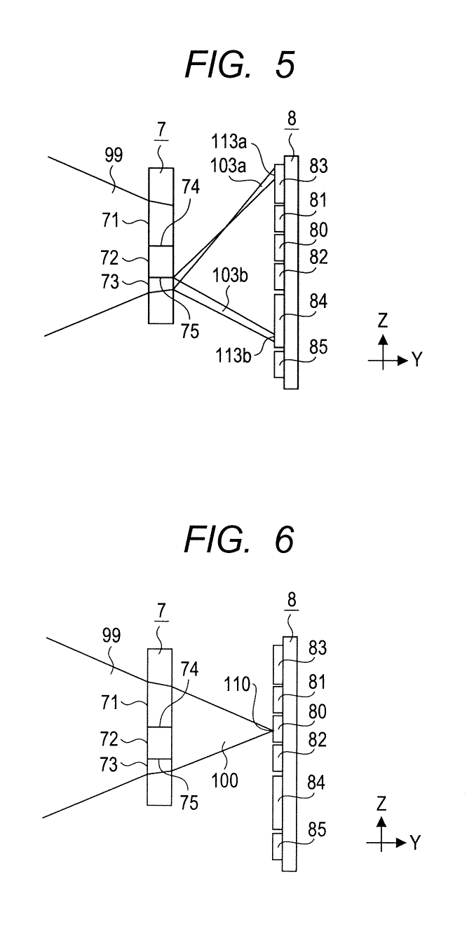

Furthermore, the portion hitting the divided region 73 of the laser beam 99 for DVD incident on the optical waveguide device 7 causes a positive first-order diffracted beam 103a and a negative first-order diffracted beam 103b to be generated as shown in FIG. 5. The positive first-order diffracted beam 103a is, like the positive first-order diffracted beams 101a and 102a, subjected to a positive lens power and forms a light spot 113a defocused, like the light spots 111a and 112a, by a predetermined amount on the light receiving surface 83 provided in the photodetector 8 as shown in FIG. 5.

Note that the light receiving surface 83 on which the light spot 113a is formed is where the light spot 112a is also formed.

The negative first-order diffracted beam 103b, on the other hand, is, like the negative first-order diffracted beams 101b and 102b, subjected to a negative lens power and forms a light spot 113b defocused, like the light spots 111b and 112b, by a predetermined amount in a direction opposite to the direction in which the light spot 113a is defocused on the light receiving surface 84 on which the light spot 112b is also formed.

A portion of the laser beam 99 for DVD incident on the optical waveguide device 7 passes, as shown in FIG. 6, as a beam 100 (zeroth-order beam) through the optical waveguide device 7 without being diffracted and hits the light receiving surface 80 that is the third from top out of the six light receiving surfaces arranged in the photodetector 8. The zeroth-order beam 100 is designed to form, in a state where the light spot converged on the optical disc 6 is in just focus, a light spot almost in just focus on the light receiving surface 80.

An example state, during DVD reproduction, of a detected beam (beam reflected from the DVD) traveling from the optical waveguide device 7 to the light receiving surfaces arranged in the photodetector 8 has been described. Next, an example of a corresponding state, during CD reproduction performed using the same optical pickup, of a detected beam (beam reflected from the CD) will be described.

Laser beams used for CDs generally range from 780 to 790 nm in wavelength to be longer than wavelengths, 650 to 660 nm, of laser beams used for DVDs. Therefore, when a laser beam for CD passes through a holographic diffraction grating in the optical waveguide device 7, it is diffracted by a larger diffraction angle than the diffraction angle by which a laser beam for DVD passing through the same holographic diffraction grating is diffracted. The holographic diffraction grating patterns for the divided regions 71 to 73 of the optical waveguide device 7 are designed taking into account the wave-optical properties as described above of laser beams and based on the laser beam arrangement in which the laser beam 99 for DVD and the laser beam 199 for CD are incident on the optical waveguide device 7 to be shifted from each other by the distance L2. Namely, the holographic diffraction grating patterns for the divided regions 71 to 73 of the optical waveguide device 7 are designed such that, during DVD reproduction, a detected beam (beam reflected from the DVD) traveling from the optical waveguide device 7 to the light receiving surfaces arranged in the photodetector 8 becomes as described above and such that, during CD reproduction, a detected beam (beam reflected from the CD) traveling from the optical waveguide device 7 to the light receiving surfaces arranged in the photodetector 8 becomes as described below.

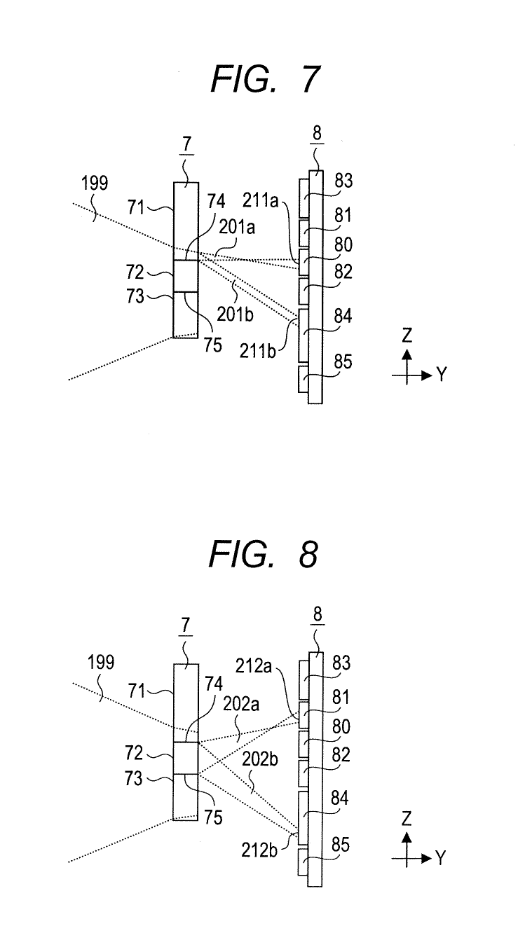

When the laser beam 199 for CD is incident on the optical waveguide device 7 during CD reproduction, positive first-order diffracted beams and negative first-order diffracted beams are generated. Referring to FIG. 7, the portion incident on the divided region 71 of the laser beam 199 is diffracted to generate a positive first-order diffracted beam 201a and a negative first-order diffracted beam 201b.

The positive first-order diffracted beam 201a hits the light receiving surface 80 that is the third from top out of the six light receiving surfaces 80 to 85 arranged in the photodetector 8.

The positive first-order diffracted beam 201a is subjected to a predetermined positive lens power, i.e. a power equivalent to that of a converging lens, generated by the holographic diffraction grating provided in the divided region 71. In a state where the light spot converged on the optical disc 6 is precisely focused, a focal point is formed in front of the photodetector 8 as shown in FIG. 7 causing a light spot 211a defocused by a predetermined amount to be formed on the light receiving surface 80 in the photodetector 8.

The negative first-order diffracted beam 201b, on the other hand, hits the light receiving surface 84 that is the fifth from top out of the six light receiving surfaces 80 to 85 as shown in FIG. 7.

Since, as described above, the positive first-order diffracted beam 201a is subjected to a predetermined positive lens power generated by the holographic diffraction grating provided in the divided region 71, the negative first-order diffracted beam 201b is inevitably subjected to a negative lens power, i.e. a power equivalent to that of a diverging lens, so that, as shown in FIG. 7, a light spot 211b defocused by a predetermined amount in a direction opposite to the direction in which the light spot 211a is defocused is formed on the light receiving surface 84.

Exactly like the beam incident on the divided region 71, the portion hitting the divided region 72 of the laser beam 199 for CD incident on the optical waveguide device 7 is diffracted to generate a positive first-order diffracted beam 202a and a negative first-order diffracted beam 202b as shown in FIG. 8. The positive first-order diffracted beam 202a is, like the positive first-order diffracted beam 201a, subjected to a positive lens power and forms a light spot 212a defocused, like the light spot 211a, by a predetermined amount on the light receiving surface 81 that is the second from top out of the six light receiving surfaces 80 to 85 arranged in the photodetector 8 as shown in FIG. 8.

The negative first-order diffracted beam 202b, on the other hand, is, like the negative first-order diffracted beam 201b, subjected to a negative lens power and forms a light spot 212b defocused, like the light spot 211b, by a predetermined amount in a direction opposite to the direction in which the light spot 212a is defocused on the light receiving surface 84.

Note that the light receiving surface 84 on which the light spot 212b is formed is where the light spot 211b is also formed.

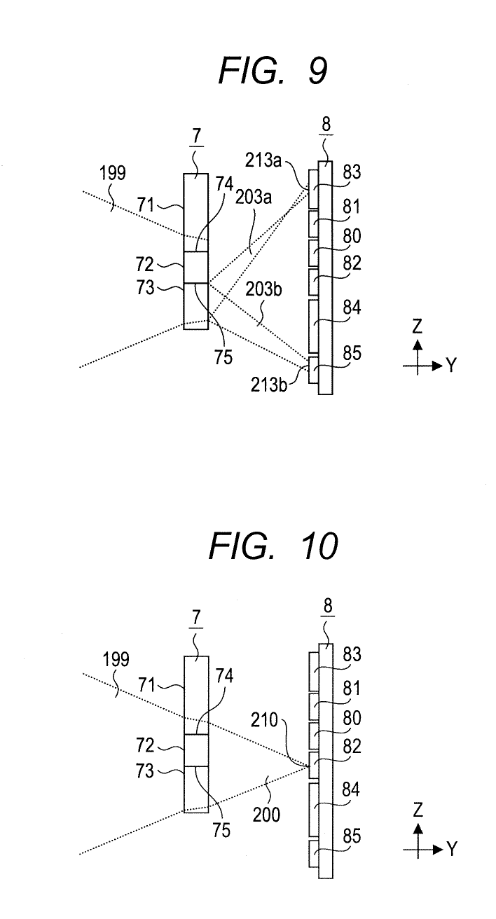

Furthermore, the portion hitting the divided region 73 of the laser beam 199 for CD incident on the optical waveguide device 7 is diffracted to generate a positive first-order diffracted beam 203a and a negative first-order diffracted beam 203b as shown in FIG. 9. The positive first-order diffracted beam 203a is, like the positive first-order diffracted beams 201a and 202a, subjected to a positive lens power and forms a light spot 213a defocused, like the light spots 211a and 212a, by a predetermined amount on the light receiving surface 83 provided in the photodetector 8 as shown in FIG. 9.

The negative first-order diffracted beam 203b, on the other hand, is, like the negative first-order diffracted beams 201b and 202b, subjected to a negative lens power and forms a light spot 213b defocused, like the light spots 211b and 212b, by a predetermined amount in a direction opposite to the direction in which the light spot 213a is defocused on the light receiving surface 85 at the bottom of the six light receiving surfaces arranged in the photodetector 8 as shown in FIG. 9.

Like in the case of the laser beam for DVD, a portion of the laser beam 199 for CD incident on the optical waveguide device 7 passes as a beam 200 (zeroth-order beam), as shown in FIG. 10, through the optical waveguide device 7 without being diffracted and hits the light receiving surface 82 that is the fourth from top out of the six light receiving surfaces arranged in the photodetector 8. The zeroth-order beam 200 is designed to form, in a state where the light spot converged on the optical disc 6 is in just focus, a light spot almost in just focus on the light receiving surface 80.

An example state of a detected beam (beam reflected from a disc) traveling from the optical waveguide device 7 to the light receiving surfaces arranged in the photodetector 8 has been described both in connection with DVD reproduction and in connection with CD reproduction. The above description, however, only represents an exemplary embodiment of the present invention, and the invention is not limited to the embodiment.

Regarding the holographic diffraction grating provided in the optical waveguide device 7, for example, the relationship between the directions of positive and negative first-order diffracted beams and the positive and negative lens powers applied to them need not be as described above, that is, they may be in a reversed relationship.

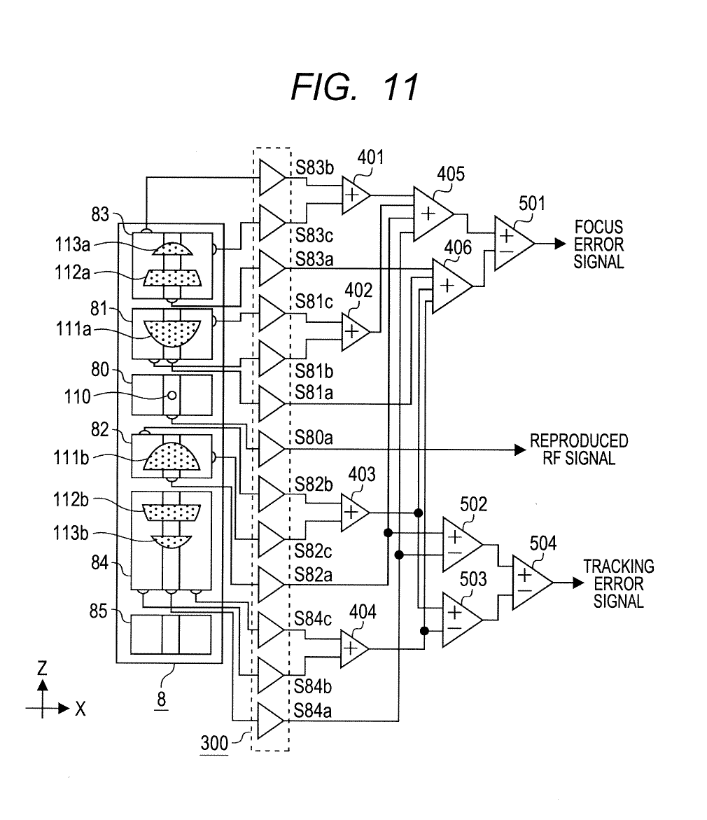

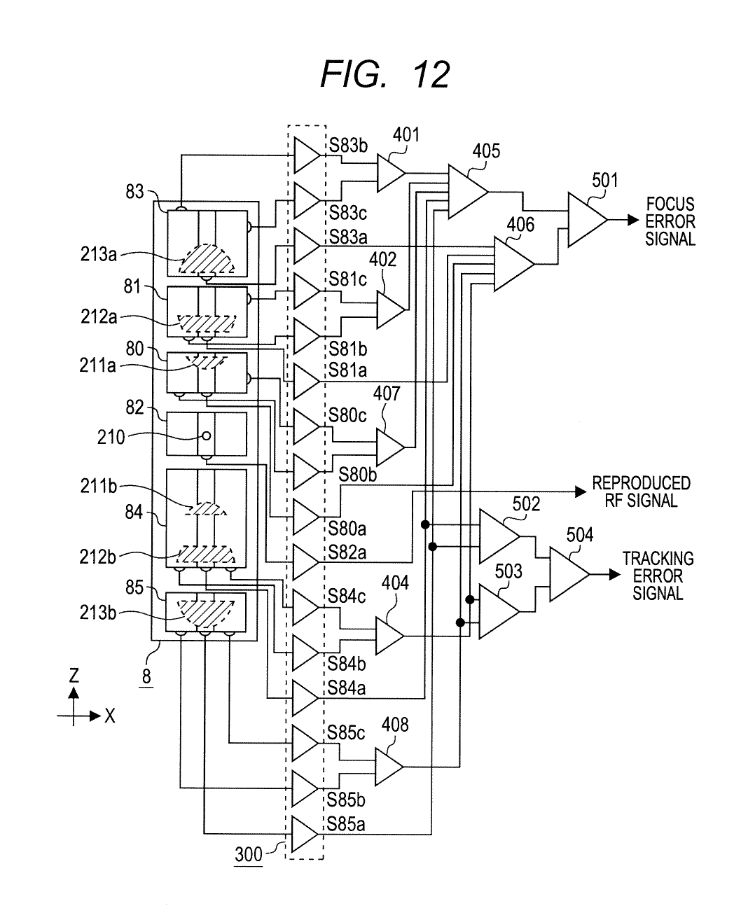

Next, an example state of a light spot formed on each light receiving surface in the photodetector 8 and example electrical circuits for detecting various signals will be outlined below with reference to FIGS. 11 and 12.

FIG. 11 shows an approximate plan view of the light spots formed, during DVD reproduction, on the light receiving surfaces 80 to 84 arranged in the photodetector 8 and an approximate circuit diagram of an example electrical circuit for detecting various signals.

Each of the light receiving surfaces 80 to 85 arranged in the photodetector 8 is divided into three regions, i.e. a belt-like center region and two side regions on both sides of the center region. Each of the three divided regions allows detection therefrom of a signal current proportional to the intensity of the light spot formed thereon. The signal current detected from each region is fed to a current-voltage converter 300 to be converted into a signal voltage. The current-voltage converter 300 has plural independent current-voltage conversion amplifiers. To facilitate the following description, the signal voltages converted from the signal currents detected from such divided regions of the light receiving surfaces arranged in the photodetector 8 will be denoted by signal names S80a and S81a to S84c as shown in FIG. 11.

As described in the foregoing with reference to FIGS. 3 to 6, the positive and negative first-order diffracted beams generated from the portion incident on the divided region 71 of the laser beam 99 for DVD incident on the optical waveguide device 7 are converged on the light receiving surfaces 81 and 82 forming the light spots 111a and 111b thereon, respectively. The portion incident on the divided region 71 of the laser beam 99 for DVD accounts for, as shown in FIG. 2, an upper half portion of the laser beam 99 divided into two by the division line 74 passing the optical axis of the laser beam 99.

As also described in the foregoing, the light spots 111a and 111b are mutually oppositely defocused by a predetermined amount.

On the light receiving surfaces 83 and 84, on the other hand, the positive and negative first-order diffracted beams generated from the portions incident on the divided regions 72 and 73 of the laser beam 99 for DVD incident on the optical waveguide device 7 are converged forming the light spots 112a and 113a and the light spots 112b and 113b, respectively.

The portions incident on the divided regions 72 and 73 of the laser beam 99 account for a lower half portion of the laser beam 99 divided into two by the division line 74 passing the optical axis 98 of the laser beam 99, i.e. the remaining half portion excluding the upper half portion incident on the divided region 71 to form the light spots 111a and 111b.

As also described in the foregoing, the light spots 112a and 112b as well as the light spots 113a and 113b are mutually oppositely defocused by a predetermined amount.

The portion passing the optical waveguide device 7 without being diffracted of the laser beam 99 is incident, as the zeroth-order beam 100, on the belt-like center region of the light receiving surface 80 forming a condensed light spot 110 thereon.

With the laser beam 99 for DVD incident on the optical waveguide device 7 dividedly diffracted to hit plural light receiving surfaces as described above, a focus error signal (FES), tracking error signal (TES), and reproduced RF signal (RF) are detected as signals complying with the following equations and based on the signals S80a and S81a to S85c that are detected, via an arithmetic circuit like the one shown in FIG. 11, from the divided light receiving surfaces.

FES(DVD)=(S81b+S81c+S83b+S83c+S82a+S84a)−(S81a+S83a+S82b+S82c+S84b+S84c) (Eq. 1)

The above equation signifies that the focus error signal is detected by a method generally referred to as a spot size detection (SSD) method. The SSD method is a well-known focus detection method, so that it will not be further elaborated below.

The tracking error signal (TES), on the other hand, is determined using the following equation.

TES(DVD)=(S82a−S84a)−{(S82b+S82c)−(S84b+S84c)} (Eq. 2)

The above equation signifies that the tracking error signal is detected by a detection method generally referred to as an advanced push-pull (APP) method or 1-beam differential push-pull (1-beam DPP) method. The APP method or 1-beam DPP method is a well-known tracking detection method, so that it will not be further elaborated below.

The reproduced RF signal (RF) is reproduced from the signal S80a detected from the center light receiving region of the light receiving surface 80 on which the zeroth-order beam converges to form the light spot 110.

Next, description will be provided in terms of CD reproduction. FIG. 12 shows an approximate plan view of the light spots formed, during CD reproduction, on the light receiving surfaces 80 to 85 arranged in the photodetector 8 and an approximate circuit diagram of an example electrical circuit for detecting various signals. The light receiving surfaces 80 to 85 arranged in the photodetector 8 referred to in the following description are identical to those shown in FIG. 11 referred to in the foregoing description connected with DVD reproduction, so that they are denoted by the same reference numerals as in FIG. 11.

To facilitate the following description, in FIG. 12 as in FIG. 11, the signal voltages converted from the signal currents detected from the divided regions of the light receiving surfaces arranged in the photodetector 8 are denoted by signal names S80a to S81c, S83a to S85c, and S82a.

During CD reproduction, the positive and negative first-order diffracted beams generated from the portions incident on the divided regions 71 and 72 of the laser beam 199 for CD incident on the optical waveguide device 7 are converged on the light receiving surfaces 80, 81, and 84 forming the light spots 211a and 212a on the light receiving surfaces 80 and 81, respectively, and the light spots 211b and 212b on the light receiving surface 84. The portions incident on the divided regions 71 and 72 of the laser beam 199 for CD combinedly account for, as shown in FIG. 2, an upper half portion of the laser beam 199 divided into two by the division line 75 passing the optical axis of the laser beam 199.

As also described in the foregoing, the light spots 211a and 211b as well as the light spots 212a and 212b are mutually oppositely defocused by a predetermined amount.

On the light receiving surfaces 83 and 85, on the other hand, the positive and negative diffracted beams generated from the portion incident on the divided region 73 of the laser beam 199 for CD incident on the optical waveguide device 7 are converged forming the light spots 213a and 213b, respectively.

The portion incident on the divided region 73 of the laser beam 199 accounts for a lower half portion of the laser beam 199 divided into two by the division line 75 passing the optical axis 198 of the laser beam 199, i.e. the remaining half portion excluding the upper half portion incident on the divided regions 71 and 72 to form the light spots 211a, 212a, 211b, and 212b.

As also described in the foregoing, the light spots 213a and 213b are mutually oppositely defocused by a predetermined amount.

The portion passing the optical waveguide device 7 without being diffracted of the laser beam 199 is incident, as the zeroth-order beam 210, on the belt-like center region of the light receiving surface 82.

With the laser beam 199 for CD incident on the optical waveguide device 7 dividedly diffracted to be incident on plural light receiving surfaces as described above, a focus error signal (FES), tracking error signal (TES), and reproduced RF signal (RF) are detected as signals complying with the following equations and based on the signals S80a to S81c, S83a to S85C, and S82 detected, via an arithmetic circuit like the one shown in FIG. 12, from the divided light receiving surfaces.

FES(CD)=(S80b+S80c+S81b+S81c+S83b+S83c+S84a+S85a)−(S80a+S81a+S83a+S84b+S84c+S85b+S85c) (Eq. 3)

The above equation signifies that the focus error signal is detected by a method generally referred to as a spot size detection (SSD) method. The SSD method is a well-known focus detection method, so that it will not be further elaborated below.

The tracking error signal (TES), on the other hand, is determined using the following equation.

TES(CD)=(S84a−S85a)−{(S84b+S84c)−(S85b+S85c)} (Eq. 4)

The above equation signifies that the tracking error signal is detected by a detection method generally referred to as an advanced push-pull (APP) method or 1-beam differential push-pull (1-beam DPP) method. The APP method or 1-beam DPP method is a well-known tracking detection method, so that it will not be further elaborated below.

The reproduced RF signal (RF) is reproduced from the signal S82a detected from the center light receiving region of the light receiving surface 82 on which the zeroth-order beam converges to form the light spot 210.

Note that the connections between elements in the arithmetic circuit like the one shown in FIGS. 11 and 12 partly differ between when reproducing a DVD as shown in FIG. 11 and when reproducing a CD as shown in FIG. 12. Such circuit connections can be switched between when reproducing a DVD and when reproducing a CD by providing the circuit with appropriate switches which are controllable for switching between DVD reproduction and CD reproduction.

As described above, it is possible, using an optical pickup 1 having an optical waveguide device 7 and a photodetector 8, to carry out DVD recording and reproduction and CD recording and reproduction.

For DVD reproduction or CD reproduction as described above, a configuration other than the above described one in which the foregoing equations 1 and 2 are used to generate control signals may also be used. For example, a focus error signal may be generated form a positive first-order diffracted beam only and a tracking error signal may be generated from a negative first-order diffracted beam only. Or, conversely, a focus error signal may be generated from a negative first-order diffracted beam only and a tracking error signal may be generated from a positive first-order diffracted beam only. The focus error signal detection methods that can be used in such cases include, for example, a knife edge method.

Even though the embodiment described above of the present invention concerns an optical pickup which can be used for both DVD recording and reproduction and CD recording and reproduction, the present invention is not limited to the embodiment. For example, the present invention can also be applied to cases in which an optical pickup common for DVDs and CDs is also used for recording/reproduction to/from a large-capacity optical disc generally referred to as a Blur-ray disc (BD).

Arithmetic units 401 to 406 and 501 to 504 which are used to generate the focus error signal and tracking error signal may be either configured with circuit parts outside the optical pickup or incorporated in the optical pickup.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An optical pickup for reading information recorded on an optical information recording medium by irradiating the medium with a laser beam, comprising:
a laser source unit which houses a plurality of laser emitting devices for emitting a plurality of laser beams mutually differing in wavelength;
an objective lens which forms, by converging a laser beam emitted from the laser source unit, a converged light spot on an information recording surface of the optical information recoding medium;
an optical waveguide device on which a laser beam reflected from the information recording surface where the converged light spot is formed is incident and which emits a zeroth-order beam and positive and negative first-order diffracted beams generated from the reflected laser beam; and
a photodetector having a plurality of light receiving surfaces on each of which the zeroth-order beam or positive or negative first-order diffracted beam generated, by the optical waveguide device, from the reflected laser beam is incident and each of which outputs a light detection signal corresponding to an optical intensity of the beam incident thereon;
wherein the optical waveguide device has at least three divided regions divided by at least two division lines extending, on the optical waveguide device, approximately in parallel with a direction along which a recording track of the optical information recording medium extends, the divided regions each causing a zeroth-order beam out of the reflected laser beam to be incident on one, on which none of the positive and negative first-order diffracted beams is incident, of the light receiving surfaces of the photodetector.

2. The optical pickup according to claim 1, wherein the two or more division lines on the optical waveguide device each extend approximately crossing an optical axis of an incident laser beam emitted from one of the laser emitting devices.

3. The optical pickup according to claim 1, wherein the optical waveguide device is a holographic diffraction grating on which unequally spaced, curved grating grooves are formed, the grooves having different diffraction patterns between the regions divided by the division lines.

4. The optical pickup according to claim 1, wherein one of the optical pickup and the photodetector includes at least a part of an arithmetic section which generates, by computation using the light detection signals obtained from the light receiving surfaces, a focus error signal, a tracking error signal and a signal of a magnitude approximately proportional to a displacement in a tracking direction of an objective lens and outputs the generated signals.

5. The optical pickup according to claim 4, wherein the arithmetic section generates a focus error signal by a spot size detection method and outputs the generated signal.

6. The optical pickup according to claim 4, wherein one of the optical pickup and the photodetector includes at least a part of an arithmetic section which generates a focus error signal from a light detection signal outputted from a first one, on which either one of the positive and negative first-order diffracted beams is incident, of the light receiving surfaces and outputs the generated light detection signal and which generates, from a light detection signal outputted from a second one on which the other one of the positive and negative first-order diffracted beams is incident of the light receiving surfaces, a tracking error signal and a signal of a magnitude approximately proportional to a displacement in a tracking direction of an objective lens and outputs the generated signals.

7. The optical pickup according to claim 6, wherein the arithmetic section generates a focus error signal by a knife edge method.
